(19) United States
(12) Patent Application Publication
(10) Pub. No.: US 2024/0176884 A1
(43) Pub. Date: May 30, 2024

(54) METHOD FOR AUTOMATICALLY UPDATING APPLICATION INSTALLED IN CONTAINER ENVIRONMENT AND COMPUTING DEVICE THEREFOR

(71) Applicant: SAMSUNG SDS CO., LTD., Seoul (KR)

(72) Inventors: Kyu Young CHOI, Seoul (KR); Sohee PARK, Seoul (KR); Jihoon CHO, Seoul (KR)

(73) Assignee: SAMSUNG SDS CO., LTD., Seoul (KR)

(21) Appl. No.: 18/378,346

(22) Filed: Oct. 10, 2023

(30) Foreign Application Priority Data
Nov. 30, 2022 (KR) 10-2022-0163952

(51) Int. Cl. G06F 21/57; H04L 9/32

(52) U.S. Cl. CPC G06F 21/57; H04L 9/3247

(57) ABSTRACT

The present disclosure relates to a method for automatically updating an application installed in a container environment, and a computing device therefor. A method for automatically updating an application installed in a container environment according to an embodiment of the present disclosure may include: receiving a cryptogram corresponding to an update package for updating the application; decrypting the cryptogram by a decryption module installed in the container environment so as to extract an update script and an electronic signature regarding the update script from the update package; verifying the electronic signature by using a verification key regarding the electronic signature; and updating the application by executing the update script if the electronic signature is successfully verified.

### CROSS-REFERENCE TO RELATED APPLICATION (S)

This application is based on and claims priority under 35 U.S.C. 119 to Korean Patent Application No. 10-2022-0163952, filed on Nov. 30, 2022, in the Korean Intellectual Property Office, the disclosure of which is herein incorporated by reference in its entirety.

### BACKGROUND OF THE INVENTION

### 1. Field of the Invention

The present disclosure relates to a method for automatically updating an application installed in a container environment, and a computing device therefor.

### 2. Description of the Prior Art

Many applications of various kinds may be installed in electronic devices. Users may check online markets and manipulate downloads of new versions such that latest versions of applications are installed, or may configure electronic devices such that updates are installed automatically.

Automatic updates may be implemented by using update scripts, and electronic signatures regarding update scripts may be generated to verify the integrity of the update scripts. That is, for the sake of an automatic update, an update package including an update script and an electronic signature regarding the same may be generated and distributed.

Upon receiving the update package, an electronic device may verify the electronic signature of the update script and if the verification is successful may automatically update the application on the basis of the received update script. However, the electronic signature may guarantee integrity of the update script, but does not guarantee confidentiality of the update script. That is, an update package is transmitted through networks and thus may be leaked to the outside by a malicious user, and this may cause the problem of information leakage in that competitors and the like may recognize the content of the application update.

### SUMMARY OF THE INVENTION

The present disclosure may provide a method for automatically updating an application installed in a container environment and a computing device therefor, wherein safer application updates can be provided in a container environment.

The present disclosure may provide a method for automatically updating an application installed in a container environment and a computing device therefor, wherein confidentiality and integrity can be implemented with regard to an update script used during an automatic update.

A method for automatically updating an application installed in a container environment according to an embodiment of the present disclosure may include: receiving a cryptogram corresponding to an update package for updating the application; decrypting the cryptogram by a decryption module installed in the container environment so as to extract an update script and an electronic signature regarding the update script from the update package; verifying the electronic signature by using a verification key regarding the electronic signature; and updating the application by executing the update script if the electronic signature is successfully verified.

The automatic update method according to an embodiment of the present disclosure may further include initially installing a package including a library for executing and updating the application, in the container environment.

The library may include: a control script configured to update the application by executing the update script; a decryption module configured to decrypt the cryptogram according to a preconfigured decryption algorithm; a verification key used when verifying the electronic signature; and a verification module configured to confirm whether the electronic signature is authentic or not by using the verification key.

The library may include: a control script configured to update the application by executing the update script; a verification key used when verifying the electronic signature; and a decryption/verification module configured to decrypt the cryptogram according to a preconfigured decryption algorithm and confirm whether the electronic signature is authentic or not by using the verification key.

A white-box cryptography technique may be applied to the decryption module.

In the receiving of a cryptogram, the cryptogram may be received from a server configured to provide an update regarding the application.

In the receiving of a cryptogram, the server may generate a cryptogram regarding the update script and the electronic signature regarding the update script by using an encryption module, and an encryption algorithm and a decryption algorithm corresponding to each other may be applied to the encryption module and the decryption module, respectively.

According to an embodiment of the present disclosure, a computer program combined with hardware and stored in a medium to execute the above-described automatic update method may be implemented.

A computing device according to an embodiment of the present disclosure may be configured to automatically update an application installed in a container environment, and may include a processor configured to receive a cryptogram corresponding to an update package for updating the application, decrypt the cryptogram by a decryption module installed in the container environment so as to extract an update script and an electronic signature regarding the update script from the update package, verify the electronic signature by using a verification key regarding the electronic signature, and update the application by executing the update script if the electronic signature is successfully verified.

In addition, the above-described aspects do not enumerate all features of the present disclosure. Various features of the present disclosure, and advantageous effects resulting therefrom, will be understood in more detail with reference to the following detailed embodiments.

A method for automatically updating an application installed in a container environment, and a computing device therefor, according to an embodiment of the present disclosure are advantageous in that applications can be updated more safely in a container environment.

In addition, a method for automatically updating an application installed in a container environment, and a computing device therefor, according to an embodiment of the present disclosure are advantageous in that both confidentiality and integrity of an update script can be verified by using a signcryption scheme. In addition, a decryption module is installed only in an object for which the update script is to be executed, thereby guaranteeing a high level of confidentiality regarding the update script.

However, advantageous effects obtainable from a method for automatically updating an application installed in a container environment, and a computing device therefor, according to embodiments of the present disclosure are not limited to the above-mentioned advantageous effects, and other advantageous effects not mentioned herein will be clearly understood from the following description by those skilled in the art to which the present disclosure pertains.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a block diagram illustrating a computing system for automatically updating an application installed in a container environment according to an embodiment of the present disclosure;

FIG. 2 is a block diagram illustrating a container environment and an application package installed in the container environment, according to an embodiment of the present disclosure;

FIG. 3 is a block diagram illustrating a computing device according to another embodiment of the present disclosure; and

FIG. 4 is a flowchart illustrating a method for automatically updating an application installed in a container environment according to an embodiment of the present disclosure.

### DETAILED DESCRIPTION OF THE EXEMPLARY EMBODIMENTS

Hereinafter, embodiments disclosed herein will be described in detail with reference to the accompanying drawings, wherein identical or similar components will be given identical reference numerals, and repeated descriptions thereof will be omitted. In the following descriptions, suffixes “module” and “portion” used in conjunction with components are added or used interchangeably only in view of convenience of descriptions, and do not have intrinsic meanings of roles distinguished from each other. That is, the term “portion” as used herein refers to a software or hardware component such as an FPGA or an ASIC, and performs However, “portions” are not limited to specific roles. software or hardware. A “portion” may be configured to exist in an addressable storage medium, or may be configured to play one or more processors. Therefore, “portions” include, for example, components such as software components, object-oriented software components, class components, and task components, processes, functions, attributes, procedures, subroutines, program code segments, drivers, firmware, micro-codes, circuits, data, databases, data structures, tables, arrays, and parameters. Functions provided inside components and “portions” may be combined with a smaller number of components and “portions” or may be further separated into additional components and “portions”.

In addition, in connection with describing embodiments disclosed herein, detailed descriptions of relevant known arts may be omitted if deemed to unnecessarily obscure the gist of embodiments disclosed herein. In addition, the accompanying drawings are only for helping understanding of embodiments disclosed herein, do not limit the technical idea disclosed herein, and are to be understood as encompassing all changes, equivalents, or replacements falling within the idea and technical scope of the present disclosure.

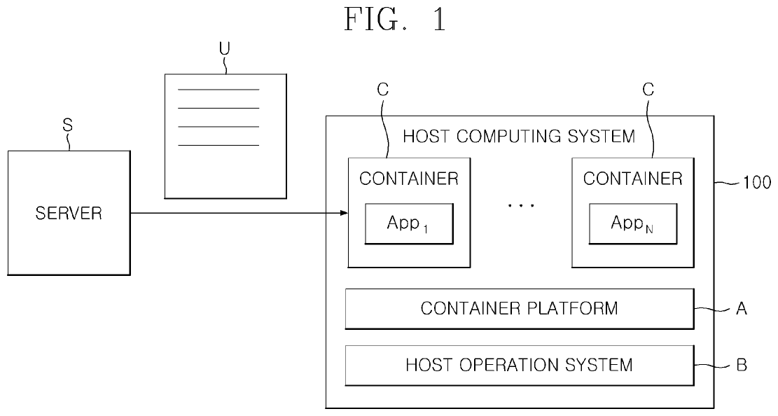

FIG. 1 is a block diagram illustrating a computing system for automatically updating an application installed in a container environment according to an embodiment of the present disclosure.

Referring to FIG. 1, the computing system according to an embodiment of the present disclosure may include a computing device 100 and a server S.

The computing system according to an embodiment of the present disclosure will now be described with reference to FIG. 1.

The computing device 100 may be a device, such as a server, including computing resources such as a processor and a memory, and may support virtualization of the computing resources included in the computing device 100. For example, the computing device 100 may provide a container environment through virtualization, and users may independently install and execute respective applications and the like as desired in the container environment. As illustrated in FIG. 1, a single computing device 100 may include multiple containers C.

The computing device 100 may include a container platform A and a host operation system B in order to implement a container environment. The container platform A may include a container runtime, an orchestrator, or the like, and the host operation system B may control computing resources of the computing device 100 to be able to execute the container platform A or the like.

Referring to FIG. 1, multiple applications App₁, . . . , App_{N} may be installed in respective containers C. Although only one application is illustrated in FIG. 1 for each container C, this is not limitative, and various numbers of applications may be installed in a single container C depending on the embodiment. A user may connect a storage device or the like to the computer device 100 and directly install an application in his/her container C, and may download and install an application from an external server S or the like connected through a network, depending on the embodiment.

The manufacturer or the like of an application may provide an update in order to improve the performance of the application, to add contents, or to remove errors. Depending on the embodiment, it is also possible to automatically update respective applications on line.

The server S may be connected to the computing device 100 through a wired or wireless network, and may support automatic updates of applications installed in respective containers C inside the computing device 100. Depending on the embodiment, the server S may further include and perform a function of transmitting an application in order to install the application, in addition to updating the application. That is, a single server S may be implemented to perform both a function of providing an application itself and providing an update of the application.

The server S may be directly operated by a manufacturer who manufactures and manages applications, but is not limited thereto. For example, the server S may be connected to multiple application manufacturers or the like and implemented so as to collect updates or the like regarding respective applications and to distribute the collected updates to respective computing devices, containers, or the like in which the applications are installed.

As illustrated in FIG. 1, if applications need to be updated, the server S may provide an update package U for updating respective applications to containers C inside the computing device 100. A single computing device 100 may include multiple containers C, and different kinds of applications may be installed in respective containers C. Therefore, the server S may specify a container C in which applications to be updated are installed and may provide a corresponding update package U thereto.

In order to support application updates, the server S may generate an update script for each application update or may receive update scripts from manufacturers or the like. In order to verify the integrity of an update script, the server S may generate electronic signature regarding the update script. That is, the server S may generate an electronic signature by using a signature key, and a verification key corresponding to the signature key may be distributed in advance to each container or the like in which the application is installed. The server S may then generate an update script for the update and an update package U including the electronic signature or the like of the application.

Upon receiving the update package U, the container C may verify the electronic signature of the update script and, if the verification succeeds, may update the application on the basis of the received update script.

However, the electronic signature may guarantee integrity of the update script, but does not guarantee confidentiality of the update script. That is, an update package U is transmitted through networks and thus may be leaked to the outside by a malicious user, and this may cause the problem of information leakage, in some cases, in that competitors and the like may steal the update package U and recognize the content of the application update. In addition, a hacker who stole the update package U may identify vulnerabilities or the like of the application from the update script, thereby causing security problems such as attacks using the same.

Therefore, a computing system according to an embodiment of the present disclosure may encrypt and provide an update package U to prevent problems caused by leakage of the update package U to the outside. That is, both confidentiality and integrity of the update package may be implemented by encrypting the electronic signature regarding the update script and the entire update package.

To this end, the server S may further include an encryption module, thereby encrypting the update package. That is, the encryption module may generate a cryptogram corresponding to the update package, and the server S may transmit the cryptogram to a container C inside the computing device 100. Therefore, it is possible to prevent the detailed content of an update script or the like from leaking to the outside even when the same is leaked to the outside while being transmitted through a network.

Hereinafter, a computing device 100 according to an embodiment of the present disclosure will be described.

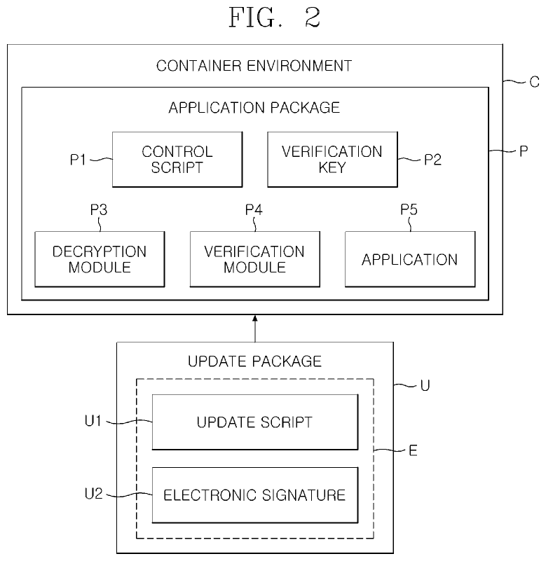

Referring to FIG. 2, a package P including an application and a library for executing and updating the application may be installed in a container environment C inside the computing device 100. The entire package P may be installed together when the application is installed, and the package P may include a control script P1, a verification key P2, a decryption module P3, a verification module P4, and an application P5. The library corresponds to the control script P1, the verification key P2, the decryption module P3, and the verification module P4 excluding the application P5, but is not limited thereto, and may further include other additional components.

If the application P5 installed in the container C needs to be updated, the container C may receive an update package U from the server S, and the update package U may be received as an encrypted cryptogram E.

Since the update package U has been encrypted, the received cryptogram E needs to be decrypted first in order to update the application P5. To this end, the package P may have a decryption module P2 preinstalled therein, and the decryption module P2 may decrypt the cryptogram E according to a decryption algorithm preconfigured during installation. That is, a decryption algorithm capable of decrypting the cryptogram E may be preconfigured in the decryption module P2 so as to correspond to an encryption algorithm for encrypting the update package U of the application. For example, the manufacturer or the like may preconfigure each encryption algorithm and decryption algorithm and may provide a package P configured such that, when an application P5 is installed in the container C, a decryption module P2 having a corresponding decryption algorithm applied thereto is installed together with the application P5. However, the encryption module provided in the server S and the decryption module provided inside the package P are different from each other, and an encryption algorithm or the like, which makes it impossible to infer the decryption module P2 from the encryption module, or to infer the encryption module from the decryption module P2, may be used. The encryption module is installed in the server S, and the decryption module P2 is installed in the container C in which the update script U1 is executed, thereby better guaranteeing the confidentiality of the update package U.

In addition, depending on the embodiment, a white-box cryptography (WBC) technique may be applied to the decryption module P2 or the encryption module.

The decryption module P2 may decrypt the cryptogram E, thereby extracting the update scrip U1, the electronic signature U2 regarding the update script, and the like from the update package U.

The verification module P4 may then verify the integrity of the update script U1 according to an electronic signature algorithm. That is, the verification module P4 may confirm whether the electronic signature U2 of the update script U1 is authentic or not by using the verification key P3. The verification key P3 may be included in the package P during application installation and then stored in the container C. The verification key P3 is paired with the signature key stored in the server S, and may be stored in a predesignated space inside the computing device 100. Therefore, the verification module P4 may verify the electronic signature U2 of the update script U1 by using the verification key P3 included in the package P.

Meanwhile, depending on the embodiment, the decryption module P2 and the verification module P4 may be implemented as a single decryption/verification module (not illustrated). That is, the decryption/verification module may decrypt the cryptogram E according to a preconfigured decryption algorithm, and may confirm whether the electronic signature U2 is authentic by using the verification key P3. A signcryption scheme may be applied to the decryption/verification module such that decryption and electronic signature verification are performed simultaneously, thereby verifying both confidentiality and integrity of the update package U.

Upon successfully verifying the electronic signature of the update script U1, the control script P1 may execute the update script U1, thereby updating the application P5. The control script P1 may execute another script, and may be configured such that the user can execute the same as desired. This enables the user account for automatic updating to execute the control script P1 as desired. The user account for automatic updating, as used herein, may be a user account having no password configured therefor.

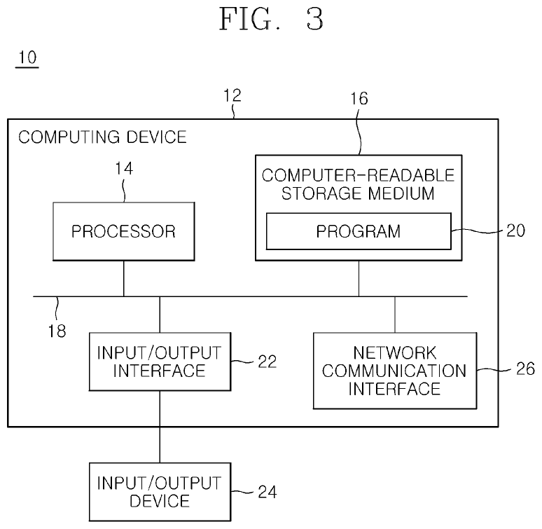

FIG. 3 is a block diagram illustrating a computing environment 10 which is appropriately used in exemplary embodiments. In the illustrated embodiment, respective components may have different functions and abilities in addition to those described below, and additional components other than those described below may be included.

The illustrated computing environment 10 includes a computing device 12. In an embodiment, the computing device 12 may be a device (for example, a computing device 100) for automatically updating an application installed in a container environment.

The computing device 12 includes at least one processor 14, a computer-readable storage medium 16, and a communication bus 18. The processor 14 may cause the computing device 12 to operate according to the above-mentioned exemplary embodiment. For example, the processor 14 may execute one or more programs stored in the computer-readable storage medium 16. The one or more programs may include one or more computer-executable instructions, and the computer-executable instructions may be configured such that, when executed by the processor 14, the computing device 12 performs operations according to an exemplary embodiment.

The computer-readable storage medium 16 is configured to store computer-executable instructions or program codes, program data and/or other appropriate types of information. The program 20 stored in the computer-readable storage medium 16 includes a set of instructions that can be executed by the processor 14. In an embodiment, the computer-readable storage medium 16 may be a memory (a volatile memory such as a random access memory, a nonvolatile memory, or an appropriate combination thereof), one or more magnetic disk storage devices, optical disk storage devices, flash memory devices, other types of storage media which can be accessed by the computing device 12, and which can store desired information, or an appropriate combination thereof.

The communication bus 18 interconnects various other components of the computing device 12, including the processor 14 and the computer-readable storage medium 16.

The computing device 12 may include one or more input/output interfaces 22 configured to provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. Exemplary input/output devices 24 may include input devices such as a pointing device (a mouse, a track pad, or the like), a keyboard, a touch input device (a touch pad, a touch screen, or the like), a voice or sound input device, various kinds of sensor devices, and/or imaging devices, and/or output devices such as a display device, a printer, a speaker, and/or a network card. An exemplary input/output device 24 may be included in the computing device 12 as a component of the computing device 12, and may be connected to the computing device 12 as a separate device distinguished from the computing device 12.

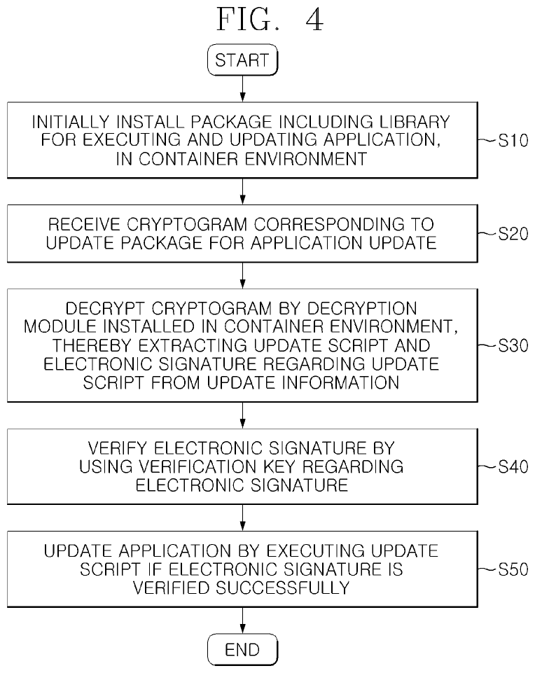

FIG. 4 is a flowchart illustrating a method for automatically updating an application installed in a container environment according to an embodiment of the present disclosure. Respective steps in FIG. 4 may be performed by a computing device 100 according to an embodiment of the present disclosure.

Referring to FIG. 4, the computing device may initially install a package including a library for executing and updating an application in a container environment according to a user input (S10). The computing device may install an application in the container environment according to a user input, and a library or the like used to execute or update the application may be installed together with the application. The user may manually install the application by connecting a storage medium or the like, in which the application is stored, to the computing device. Depending on the embodiment, it is also possible to download and install the application on line.

The library included in the application package may include a control script, a verification key, a decryption module, a verification module, and the like. Depending on the embodiment, the decryption module and the verification module may be implemented as a single decryption/verification module.

The control script may execute an update script to update the application. The decryption module may decrypt a received cryptogram according to a preconfigured decryption algorithm. A white-box cryptography technique may be applied to the decryption module. The verification key is used to verify an electronic signature, and may be stored together during initial installation. The verification module may confirm whether the electronic signature regarding the update script is authentic or not by using the verification key.

The computing device may then receive a cryptogram corresponding to an update package for application update from the server (S20). That is, the server may support application update, and may transmit an update package for application update to the computing device through a wired or wireless network. In order to maintain confidentiality of the update package, the update package may be encrypted by an encryption module. Accordingly, the server may generate a cryptogram corresponding to the update package, and may transmit the generated cryptogram to the computing device. An encryption algorithm and a decryption algorithm, which correspond to each other, may be applied to the encryption module of the server and to the decryption module inside the package, respectively.

The computing device may decrypt the received cryptogram by the decryption module installed in the container environment, and may extract the update script and the electronic signature regarding the update script from the update package (S30). That is, the update package has been encrypted, and the received cryptogram thus needs to be decrypted first in order to update the application. The decryption module may be preinstalled in the package, and may decrypt the cryptogram according to a decryption algorithm preconfigured during installation. That is, a decryption algorithm capable of decrypting the cryptogram may be preconfigured in the decryption module so as to correspond to the encryption algorithm for encrypting the update package of the application. In addition, depending on the embodiment, a white-box cryptography technique may be applied to the decryption module or the encryption module. After decryption is completed, the computing device may verify the electronic signature by using a verification key regarding the electronic signature (S40). The verification module may verify the integrity of the update script according to an electronic signature algorithm. That is, the verification module may confirm whether the electronic signature of the update script is authentic or not by using the verification key. The verification key may be included in the package during application installation and then stored in the container.

Thereafter, if the electronic signature is successfully verified, the update script may be executed to update the application (S50). That is, the control script may execute the update script to update the application. The control script executes another script, and may be configured such that the user can execute the same as desired. This enables the user account for automatic updating to execute the control script as desired. The user account for automatic updating, as used herein, may be a user account having no password configured therefor.

Meanwhile, depending on the embodiment, the decryption module and the verification module may be implemented as a single decryption/verification module. In this case, the computing device may simultaneously perform decryption and electronic signature verification by using the decryption/verification module. A signcryption scheme may be applied thereto, thereby verifying both confidentiality and integrity of the update package.

The above-described present disclosure can be implemented as a computer-readable code in a medium in which a program is recorded. A computer-readable medium may continuously store a computer-executable program or may temporarily store the same to execute or download the same. In addition, the medium may be various types of recording means or storage means combined with a single piece of hardware or multiple pieces of hardware, but is not limited to a medium which directly accesses a computer system, and may exist on a network in a distributed manner. Examples of the medium may include a magnetic medium such as a hard disk, a floppy disk, and a magnetic tape, an optical recording medium such as a CD-ROM and a DVD, a magneto-optical medium such as a floptical disk, and a ROM, a RAM, a flash memory, and the like, and may be configured such that program instructions are stored therein. Other examples of the medium may include an app store which distributes applications, a site which supplies or distributes various kinds of software, and a recording medium or a storage medium managed by a server or the like. Therefore, the above detailed description is not to be interpreted as limitative in any aspect, but to be considered exemplary. The scope of the present disclosure is to be determined by reasonable interpretation of the appended claims, and all changes falling within the equivalent scope of the present disclosure are included in the scope of the present disclosure.

The present disclosure is not limited to the above-described embodiments and the accompanying drawings. It will be obvious to those skilled in the art to which the present disclosure pertains that components according to the present disclosure can be replaced, modified, and changed without deviating from the technical idea of the present disclosure.

What is claimed is:

1. A method for automatically updating an application installed in a container environment, the method comprising:
receiving a cryptogram corresponding to an update package for updating the application;
decrypting the cryptogram by a decryption module installed in the container environment so as to extract an update script and an electronic signature regarding the update script from the update package;
verifying the electronic signature by using a verification key regarding the electronic signature; and
updating the application by executing the update script if the electronic signature is successfully verified.

2. The method of claim 1, further comprising initially installing a package comprising a library for executing and updating the application, in the container environment.

3. The method of claim 2, wherein the library comprises:
a control script configured to update the application by executing the update script;
a decryption module configured to decrypt the cryptogram according to a preconfigured decryption algorithm;
a verification key used when verifying the electronic signature; and
a verification module configured to confirm whether the electronic signature is authentic or not by using the verification key.

4. The method of claim 2, wherein the library comprises:
a control script configured to update the application by executing the update script;
a verification key used when verifying the electronic signature; and
a decryption/verification module configured to decrypt the cryptogram according to a preconfigured decryption algorithm and confirm whether the electronic signature is authentic or not by using the verification key.

5. The method of claim 1, wherein a white-box cryptography technique is applied to the decryption module.

6. The method of claim 1, wherein, in the receiving of a cryptogram, the cryptogram is received from a server configured to provide an update regarding the application.

7. The method of claim 6, wherein, in the receiving of a cryptogram, the server generates a cryptogram regarding the update script and the electronic signature regarding the update script by using an encryption module, and an encryption algorithm and a decryption algorithm corresponding to each other are applied to the encryption module and the decryption module, respectively.

8. A computer program combined with hardware and stored in a medium to execute the method of claim 1.

9. A computing device configured to automatically update an application installed in a container environment, the computing device comprising a processor configured to:
receive a cryptogram corresponding to an update package for updating the application;
decrypt the cryptogram by a decryption module installed in the container environment so as to extract an update script and an electronic signature regarding the update script from the update package;
verify the electronic signature by using a verification key regarding the electronic signature; and
update the application by executing the update script if the electronic signature is successfully verified.
